(19) United States
(12) Patent Application Publication
(10) Pub. No.: US 2026/0332448 A1
(43) Pub. Date: Oct. 22, 2026

(54) CAN NODE CONNECTION TO HOSTS

(71) Applicant: Infineon Technologies AG, Neubiberg (DE)

(72) Inventors: Vivin Richards Allimuthu Elavarasu, Taufkirchen (DE); Thomas Mullane, Dublin (DE); Achim Vowe, Merching (DE); Albrecht Rommel, München (DE); Sanjay Kumar Singh, Ottobrunn (DE)

(21) Appl. No.: 19/649,198

(22) Filed: Apr. 16, 2026

(30) Foreign Application Priority Data
Apr. 16, 2025 (DE) 10 2025 114 894.5

(51) Int. Cl. H04L 12/40; H04J 3/06

(52) U.S. Cl. CPC H04L 12/40019; H04J 3/0697; H04L 2012/40215

(57) ABSTRACT

A device is able to connect a CAN network to a host for example by Ethernet. A CAN controller block may be connected to a CAN transceiver and through the CAN transceiver to a CAN network. The CAN controller block has a transmit buffer for buffering data to be transmitted to the CAN network. The CAN network is to be connected to hosts. A data communication block is connected between the CAN controller block and the hosts. A master interface is connected between the data communication block and the plurality of hosts arranged to receive data from the plurality of hosts and transmit it through the data communication block to the CAN controller block and receive data from the CAN controller block, identify the host corresponding to the data and transmit the data to the respective host.

### REFERENCE TO RELATED APPLICATION

This Application claims the benefit of German Application number 10 2025 114 894.5, filed on Apr. 16, 2025, the contents of which are hereby incorporated by reference in their entirety.

### FIELD OF THE INVENTION

There is provided a semiconductor device for connecting a controller area network, CAN, to one of a plurality of hosts, a CAN network connected to the Ethernet and methods of connecting the CAN network to hosts including for example an Ethernet host.

### BACKGROUND OF THE INVENTION

A controller area network (CAN) is a communications protocol for a communications bus widely used in the automotive industry. Developments of CAN include CAN FD and CAN XL; all of these CAN standards will be referred to as CAN in the following.

As the Ethernet communications standard becomes increasingly important in automotive applications, for example as a network backbone, there is a need for interconnecting CAN and Ethernet networks. There may be a need to connect the CAN network to more than one host, for example an Ethernet host and an internal program.

### SUMMARY OF THE INVENTION

In an example, there is provided a semiconductor device for connecting a CAN network to a host, comprising:
a controller area network, CAN controller block for connection to a CAN transceiver and through the CAN transceiver to a CAN network, wherein the CAN controller block comprises a transmit buffer for buffering data to be transmitted to the CAN network;
a. a plurality of hosts; and
b. a data communication block connected between the CAN controller block and the hosts; and
c. a master interface implemented in hardware connected between the data communication block and the plurality of hosts arranged to receive data from the plurality of hosts and transmit it through the data communication block to the CAN controller block and arranged to receive data from the CAN controller block, identify the host corresponding to the data and transmit the data to the respective host.

In an example, there is provided a network comprising:
a semiconductor device according to any preceding claim;
a CAN transceiver connected to the CAN block;
a CAN network connected to the CAN transceiver;
an Ethernet interconnect connected to the Ethernet interface to provide the Ethernet network; and
wherein the plurality of hosts includes an Ethernet interface as an Ethernet host connected to the Ethernet interconnect.

In an example, there is provided a method of operating a semiconductor device connecting a CAN network to a plurality of hosts, wherein at least one host is an Ethernet host, comprising:
a controller area network, CAN controller block for connection to a CAN transceiver and through the CAN transceiver to a CAN network, wherein the CAN controller block comprises a transmit buffer for buffering data to be transmitted to the CAN network;
an Ethernet interface for connection to an Ethernet network connected to the Ethernet host; and
a data communication block connected between the CAN controller block and the Ethernet interface; and
a master interface implemented in hardware connected between the data communication block and the plurality of hosts arranged to receive data from the plurality of hosts and transmit it through the data communication block to the CAN controller block.

### BRIEF DESCRIPTION OF THE DRAWINGS

Examples of the invention will now be described, purely by way of example, with reference to the accompanying drawings, in which:

FIG. 1 illustrates a first example of a device with a CAN controller block and a plurality of hosts, and

FIG. 2 illustrates a second example of a device with a CAN controller block and a plurality of hosts

### DETAILED DESCRIPTION

An example of the invention will be presented, purely by way of example.

A semiconductor device such as a microcontroller may have a number of hosts. One host may be for example applications software running on a core; such hosts present in the semiconductor device may be referred to as internal hosts. Another host may not be implemented on the semiconductor device but may be a remote host, connected over a network link to the microcontroller. For example, the remote host may be a device connected through an Ethernet link to the microcontroller. Such remote hosts will be referred to as Ethernet hosts in the following. It will be appreciated that there may be one or more internal hosts and one or more remote hosts running simultaneously.

When more than one host is to be connected to CAN, a separate CAN controller block may be provided for each host with each CAN controller block connected to a respective transceiver which is then connected to a CAN network. Problems can occur if this is not done; in particular, there is a risk that priority inversion can occur as low priority frames can block the transmission of high priority frames.

In order to connect more than one host to a single CAN bus there is therefore the possibility of providing a CAN controller block for each host and then implementing in hardware transceiver sharing logic between the CAN controller blocks and a CAN transceiver for sharing the transceiver. However, this method uses two CAN controller blocks and therefore takes up unnecessary chip area; this method is therefore costly.

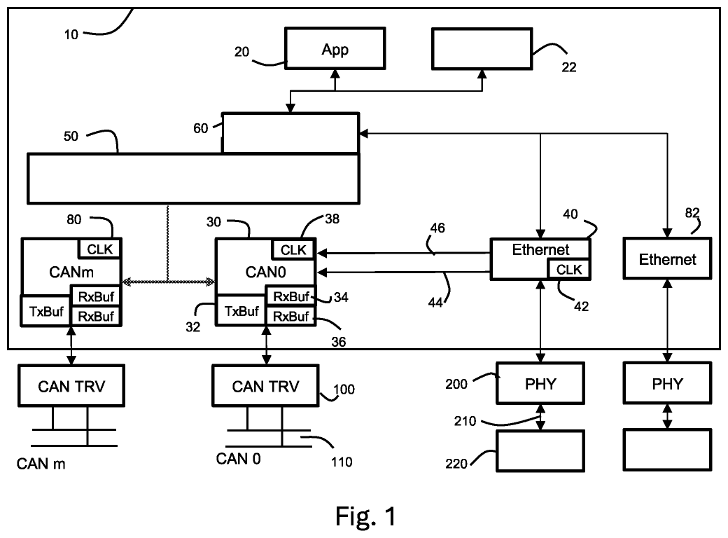

Instead, the inventors propose a hardware device, an example of which is illustrated in FIG. 1.

A semiconductor device 10 is in the example a microcontroller with a core, memory and various input output arrangements. The device 10 has a first host 20 which in this example is an application running on a core, and a second host 22 which in the example is a network accelerator.

A CAN controller block 30 includes a transmission buffer 32, a first receive buffer 34, a second receive buffer 36 and a free-running internal clock 38.

FIG. 1 shows the CAN controller block 30 being connected to an external CAN transceiver 100 and hence to a CAN network 110.

The device also includes an Ethernet block 40 containing an internal free-running clock 42.

FIG. 1 shows the Ethernet block 40 being connected to an externa Ethernet physical layer (PHY) 200 which in turn is connected through Ethernet link 210 to an external device 220. Note, the Ethernet block 40 is also a host, i.e. a device that may require access to the CAN network 110.

A data communication block 50 is provided connected to the CAN controller block 30 and this in turn is connected to hardware master interface 60, which is in turn connected to the Ethernet block 40 and to the application 20. This block carries out the step of merging the traffic from the application and the Ethernet host into a single transmit buffer 32 in the CAN controller block 30. All messages from this buffer then participate in the arbitration process of the CAN network.

A direct connection is provided between the Ethernet block 40 and the CAN controller block 30; in particular a start/reset line 44 and a rollover line 46

In use, both the application host 20 and the Ethernet block 40 are hosts that require connection to a single CAN network 110. The single CAN transceiver 100 and CAN controller block 30 are used for both hosts.

In order to transmit data to the CAN network, the master interface 60 in this example polls the hosts in turn. Thus, first application 20 is polled to see if application 20 has data for transmission; if so, the data is loaded into transmission buffer 32. Then, the Ethernet block 40 is polled to see if the Ethernet block 40 has data for transmission; if so the data is transmitted through master interface 60 and data communications block 50 to CAN controller block 30 which stores the data in the transmission buffer 32. The CAN controller block 30 then creates CAN frames and transmits them to the CAN transceiver 100 for transmission over CAN network 110 at the appropriate times in accordance with the CAN standard.

Similarly, CAN transceiver 100 receives CAN frames from the network and transmits them to CAN controller 30. The data is stored in either receiver buffer 34 if the data is for application 20 or in receive buffer 36 if the data is for the Ethernet block 40. In other words, each host has a respective buffer assigned. In this way, if for some reason one of the buffer fills, for example because Ethernet communication is temporarily unavailable, data for the other host can continue to be received. This prevents the stopping or temporary availability of one of the hosts from preventing receipt of messages for another host, as only the buffer for the respective host fills.

Another aspect is also shown. When the Ethernet block 40 starts or resets its free-running Ethernet clock 42 it signals this to the CAN controller block 30 along start/reset signal line 44. This then sets the free-running CAN clock 38 in the CAN controller block 30 to the same time, zero, so that the Ethernet clock in the Ethernet block 40 and the CAN clock CAN block 30 are synchronized.

By doing this, the timestamp used to track CAN frames is already in synch with the Ethernet network. In this way, a measurement can be taken for example in a remote node and timestamped with a time on the CAN network. This can then be passed to a node on the Ethernet network using Ethernet time and correctly interpreted.

Similarly, when the Ethernet clock 42 rolls over this is signaled using rollover signal line 46.

Note that this arrangement has the advantage that the hardware functions in a variety of use cases. If a particular semiconductor device has no need of Ethernet the Ethernet block 40 may be unpowered to reduce power consumption. In this case, the CAN clock 38 simply operates as a free-running clock. Only if the Ethernet block is started does the synchronization method synchronize the clocks.

A further aspect may be provided in that the Ethernet clock 42 may be synchronized with the network time used on the Ethernet link 210. Both sides may start with a timer at zero and then each can keep track of the other to keep in sync.

As illustrated in FIG. 1, CAN controller block 30 is shared by two hosts 20,40. However, there may be further CAN controller blocks 80 indicated here schematically as CANm. There may be CAN controller blocks 80 numbered m=0, 1, 2 . . . , up to any number as required. Additional hosts 22, 82 may be shared by the further CAN controller blocks or can operate independently. In this example, host 22 may be a network adapter and host 82 a further Ethernet block but it will be appreciated that any of a number of different varieties of host may be required and implemented.

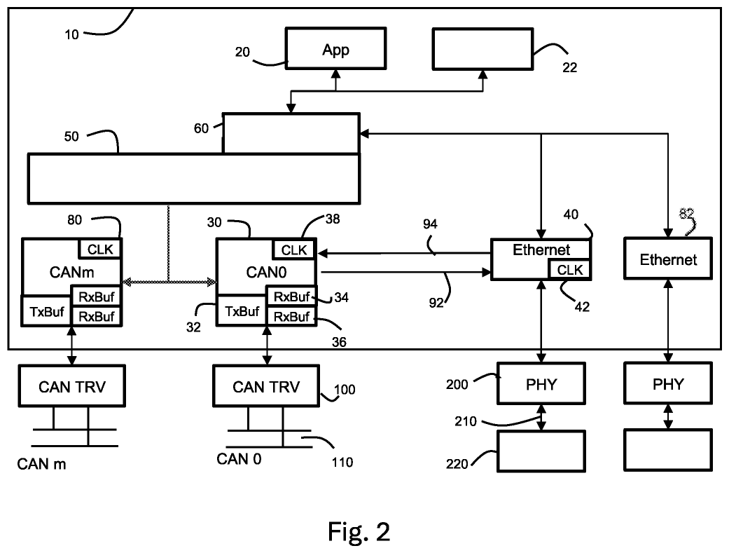

As illustrated in FIG. 2, an alternative mechanism for aligning clocks may be provided. In this case, there is a two-way interconnect having a poll line 92 and a time line 94 provided between CAN block 30 and Ethernet block 40. The CAN controller block 30 periodically polls the Ethernet block 40 and if the Ethernet block is active the Ethernet block then delivers the time from Ethernet clock 42 which is used to update CAN clock 38.

The devices discussed above allow the sharing of a single CAN bus between two hosts without needing two CAN controller blocks; this is efficient and greatly reduces the required silicon area.

Moreover, the time synchronization requires minimal routing; only two interconnects need to be routed between Ethernet block and CAN block which provides synchronization at low complexity.

Neither the time synchronization nor the sharing of the CAN bus require software operating on the core.

These adaptations allow a variety of use cases to be addressed at low cost.

Although specific embodiments/examples/aspects have been illustrated and described herein, it will be appreciated by those of ordinary skill in the art that a variety of alternate and/or equivalent implementations may be substituted for the specific examples shown and described without departing from the scope of the present invention. This application is intended to cover any adaptations or variations of the specific examples discussed herein. Therefore, it is intended that this invention be limited only by the claims and the equivalents thereof.

It should be noted that the examples as outlined in the present document may be used stand-alone or in combination with the other methods and systems disclosed in this document. In addition, the features outlined in the context of an apparatus are also applicable to a corresponding method, and vice versa. Furthermore, all aspects of the methods and apparatus outlined in the present document may be arbitrarily combined. In particular, the features of the claims may be combined with one another in an arbitrary manner.

It should be noted that the description and drawings merely illustrate the principles of the proposed methods and systems. Those skilled in the art will be able to implement various arrangements that, although not explicitly described or shown herein, embody the principles of the invention and are included within its spirit and scope. Furthermore, all examples and embodiment outlined in the present document are principally intended expressly to be only for explanatory purposes to help the reader in understanding the principles of the proposed methods and systems. Furthermore, all statements herein providing principles, aspects, and embodiments of the invention, as well as specific examples thereof, are intended to encompass equivalents thereof.

What is claimed is:

1. A semiconductor device for connecting a CAN network to a host, comprising:
a controller area network (CAN) controller block for connection to a CAN transceiver and through the CAN transceiver to a CAN network, wherein the CAN controller block comprises a transmit buffer for buffering data to be transmitted to the CAN network;
a plurality of hosts;
a data communication block connected between the CAN controller block and the hosts; and
a master interface implemented in hardware connected between the data communication block and the plurality of hosts arranged to receive data from the plurality of hosts and transmit it through the data communication block to the CAN controller block and arranged to receive data from the CAN controller block, identify the host corresponding to the data and transmit the data to the respective host.

2. The semiconductor device of claim 1,
wherein the CAN controller block further comprises a plurality of receive buffers for buffering data, each receive buffer arranged to buffering data received from the CAN Network for a respective host; and
the data communication block is arranged to transmit data from the receive buffers to the respective hosts via the master interface.

3. The semiconductor device of claim 1, wherein the plurality of hosts includes an Ethernet interface for connection to an Ethernet network.

4. The semiconductor device of claim 3, wherein the Ethernet interface includes a free-running Ethernet clock;
the CAN controller block contains a free-running CAN clock,
wherein the CAN controller block is arranged to synchronize the free-running CAN clock with the free-running Ethernet clock; and
the CAN block is arranged to create CAN frames with a timestamp using the free-running CAN clock.

5. The semiconductor device of claim 4, wherein the semiconductor device is arranged to synchronize the free-running Ethernet clock with an Ethernet system time.

6. The semiconductor device of claim 4, wherein the CAN block is arranged to poll the Ethernet block to request the time of the free-running Ethernet clock and to update the CAN clock with the time of the free-running Ethernet clock.

7. The semiconductor device of claim 4, wherein the Ethernet block is arranged to transmit a start signal to the CAN block when the free-running Ethernet clock is started or reset, and wherein the CAN controller block is arranged to reset the CAN clock when the start signal is received.

8. The semiconductor device of claim 7, wherein the Ethernet block is further arranged to transmit a rollover signal to the CAN block when the free-running Ethernet clock rolls over and wherein the CAN controller block is arranged to reset the CAN clock when the rollover signal is received.

9. The semiconductor device of claim 1, wherein the plurality of hosts includes a plurality of Ethernet interfaces.

10. An Ethernet interface, comprising
a free-running Ethernet clock;
wherein the Ethernet interface is configured to
provide data to a master interface for transmission through a data communication block to a controller area network (CAN) controller block; and
synchronize a free-running CAN clock of the CAN controller block with the free-running Ethernet clock.

11. The Ethernet interface of claim 10, further configured to provide the time of the free-running Ethernet clock to the CAN controller block in response to a polling request from the CAN block.

12. The Ethernet interface of claim 10, further configured to transmit a start signal to the CAN block when the free-running Ethernet clock is started or reset, and wherein the CAN controller block is arranged to reset the CAN clock when the start signal is received.

13. The Ethernet interface of claim 10, further configured to transmit a start signal to the CAN controller block when the free-running Ethernet clock is started or reset.

14. The Ethernet interface of claim 13, further configured to transmit a rollover signal to the CAN block when the free-running Ethernet clock rolls over.

15. A controller area network (CAN) controller block for connection to a CAN transceiver and through the CAN transceiver to a CAN network, comprising
a free-running CAN clock;
wherein the CAN controller block is configured to
synchronize the free-running CAN clock with an Ethernet clock;
receive data from a data communication block; and
provide the data to the CAN transceiver.

16. The CAN controller block of claim 15, further comprising a plurality of receive buffers for buffering data, each receive buffer arranged to buffering data received from the CAN Network for a respective host.

17. The CAN controller block of claim 15, further configured to poll an Ethernet interface to request the time of the Ethernet clock and to update the CAN clock with the time of the Ethernet clock.

18. The CAN controller block of claim 15, further configured to
receive a start signal from an Ethernet interface that indicates that the Ethernet clock is started or reset; and
wherein the CAN controller block is arranged to reset the CAN clock when the start signal is received.

19. The CAN controller block of claim 18, further configured to
receive a rollover signal from the Ethernet interface that indicates that the Ethernet clock rolls over; and
reset the CAN clock in response to the rollover signal.

20. The CAN controller block of claim 15, wherein the Ethernet clock is a free-running Ethernet clock of an Ethernet interface.
